(19) United States
(12) Patent Application Publication
(10) Pub. No.: US 2011/0139767 A1
(43) Pub. Date: Jun. 16, 2011

(54) AMRPHOUS SILICON CRYSTALLIZATION APPARATUS

(75) Inventors: Beong-Ju KIM, Yongin-city (KR); Ji-Su AHN, Yongin-city (KR); Cheol-Ho YU, Yongin-city (KR)

(73) Assignee: SAMSUNG MOBILE DISPLAY CO., LTD.,, Yongin-city (KR)

(21) Appl. No.: 12/898,195

(22) Filed: Oct. 5, 2010

(30) Foreign Application Priority Data
Dec. 15, 2009 (KR) 10-2009-0124723

(51) Int. Cl. H05B 3/06; H05B 3/22

(52) U.S. Cl. 219/521; 219/541

(57) ABSTRACT

Provided is an amorphous silicon (a-Si) crystallization apparatus for crystallizing a-Si into polysilicon (poly-Si), and more particularly, to an a-Si crystallization apparatus for crystallizing a-Si into poly-Si by applying a certain power voltage to a conductive thin film disposed on a substrate including an a-Si layer to generate joule heat, wherein the a-Si formed on the substrate can be crystallized using the same equipment regardless of the size of the substrate. The a-Si crystallization apparatus includes a process chamber, a substrate holder disposed at a lower part of the process chamber, a power voltage application part disposed at an upper part of the process chamber and including a first electrode and a second electrode having a polarity different from the first electrode, and a controller for adjusting a distance between the first and second electrode.

### CLAIM OF PRIORITY

This application claims the benefit of Korean Patent Application No. 2009-124723, filed Dec. 15, 2009, the disclosure of which is hereby incorporated herein by reference in its entirety.

### BACKGROUND OF THE INVENTION

1. Field of the Invention

An aspect of the described technology relates generally to an amorphous silicon (a-Si) crystallization apparatus for crystallizing a-Si into polysilicon (poly-Si), and more particularly, to an a-Si crystallization apparatus for crystallizing a-Si into poly-Si by applying a certain power voltage to a conductive thin film disposed on a substrate including an a-Si layer to generate joule heat, wherein the a-Si formed on the substrate can be crystallized using the same equipment regardless of the size of the substrate.

2. Description of the Related Art

Flat panel display devices are widely used as display devices to substitute for cathode ray tube display devices due to their lightweight and compact characteristics. Typical examples of the flat panel display devices include a liquid crystal display device (LCD) and an organic light emitting diode display device (OLED). Among them, the OLED has better brightness and viewing angle characteristics than the LCD and no need of backlight, enabling a super slim structure thereof.

### SUMMARY OF THE INVENTION

Aspects of the described technology provide an amorphous silicon (a-Si) crystallization apparatus using joule heat capable of applying a certain power voltage to an accurate position of a substrate regardless of the size of the substrate, and performing a crystallization process of a-Si formed on various sizes of substrates, without modification of equipment.

According to an exemplary embodiment, an a-Si crystallization apparatus includes a process chamber, a substrate holder disposed at a lower part of the process chamber, a power voltage application part disposed at an upper part of the process chamber and including a first electrode and a second electrode having a polarity different from the first electrode, and a controller for adjusting a distance between the first and second electrodes.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic perspective view of an a-Si crystallization apparatus in accordance with an exemplary embodiment;

FIG. 2A is a cross-sectional view taken along line I-I′ of FIG. 1; and

FIG. 2B is a cross-sectional view taken along line II-II′ of FIG. 1.

### DETAILED DESCRIPTION

The OLED is a display device using a phenomenon that electrons and holes injected through a cathode and an anode into an organic thin layer combine with each other to generate excitons, and a certain wavelength of light is generated by energy from the excitons.

The OLED can be classified as a passive matrix type or an active matrix type depending on a driving method. The active matrix OLED must have two thin film transistors (TFTs), i.e., a drive transistor for applying a drive current to the OLED, and a switching transistor for transmitting a data signal to the drive transistor to determine on/off of the drive transistor, to drive the OLED including the organic thin layer. Therefore, manufacture of the active matrix OLED is more complex than the passive matrix OLED.

However, since the passive matrix OLED has problems of low resolution, increase in drive voltage, decrease in material lifespan, etc., its application is limited to low resolution and small display devices. On the other hand, the active matrix OLED can provide a stable brightness using uniform current supplied through a switching transistor and a drive transistor disposed in each pixel of a display region with low power consumption, high resolution and a large-sized display can be implemented.

Conventionally, TFTs such as the switching transistor and the drive transistor include a semiconductor layer, a gate electrode disposed at one side of the semiconductor layer and controlling current flow through the semiconductor layer, and source/drain electrodes connected to both longitudinal ends of the semiconductor layer and moving a certain current through the semiconductor layer. The semiconductor layer may be formed of polycrystalline silicon (poly-Si) or amorphous silicon (a-Si). Since the poly-Si has electron mobility higher than that of the a-Si, the poly-Si is widely used.

Here, a method of forming the semiconductor layer formed of the poly-Si generally includes forming an a-Si layer on a substrate, and crystallizing the a-Si layer using any one of solid phase crystallization (SPC), rapid thermal annealing (RTA), metal induced crystallization (MIC), metal induced lateral crystallization (MILC), excimer laser annealing (ELA), and sequential lateral solidification (SLS).

However, in the a-Si crystallization methods, since in SPC and RTA it is necessary to maintain a high crystallization temperature of the a-Si for a long time, a substrate such as a glass substrate having a relatively low thermal deformation temperature cannot be used, which decreases productivity. MIC and MILC have problems in that a metal catalyst used for crystallization remains in the poly-Si, decreasing drive characteristics of the TFT. Crystallization using lasers such as ELA and SLS provides non-uniform energy density of a laser beam irradiated from a laser oscillating apparatus, and has a certain level of protrusions on the surface of the a-Si, decreasing a breakdown voltage and reliability of the TFT.

In order to solve the problems of the crystallization, Korean Patent Application No. 2005-73076 discloses a crystallization method of disposing a conductive layer under an a-Si thin layer, and crystallizing the a-Si thin layer into a poly-Si thin layer using a high temperature of joule heat generated by applying a certain power voltage to the conductive layer. However, since an a-Si crystallization apparatus using joule heat must apply a certain power voltage to an accurate position of a substrate, equipment must be modified depending on the size of the substrate.

Reference will now be made in detail to the present embodiments, examples of which are shown in the accompanying drawings, wherein like reference numerals refer to the like elements throughout. The embodiments are described below in order to explain the present invention by referring to the figures.

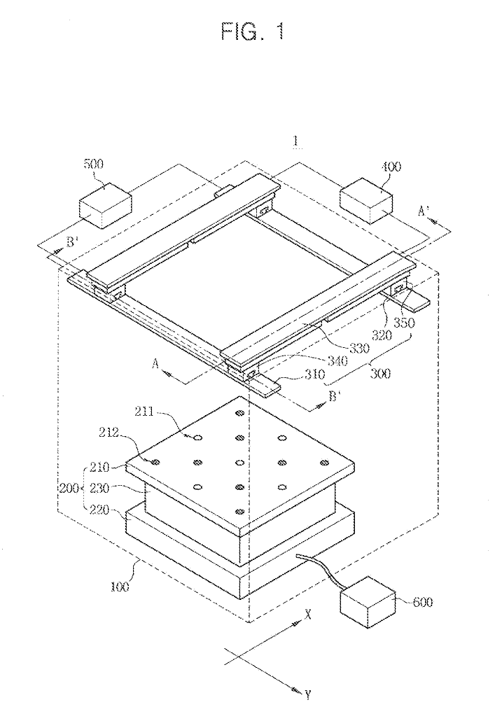

FIG. 1 is a schematic perspective view of an amorphous silicon (a-Si) crystallization apparatus in accordance with an exemplary embodiment.

Referring to FIG. 1, an a-Si crystallization apparatus 1 in accordance with an exemplary embodiment includes a process chamber 100, a substrate holder 200 disposed at a lower part of the process chamber 100, a power voltage application part 300 disposed at an upper part of the process chamber 100 and including a first electrode 310 and a second electrode 320 having a polarity different from the first electrode 310, and a controller 400 for adjusting a distance between the first and second electrodes 310 and 320.

The process chamber 100 provides a space in which a crystallization process of a-Si is performed, and includes an entrance through which a substrate (not shown) having a-Si and conductive thin layers is introduced and discharged. The controller 400 functions to apply a certain power voltage to an accurate position on the substrate introduced into the process chamber 100, and adjust a distance between the first and second electrodes 310 and 320 of the power voltage application part 300.

The substrate holder 200 includes a substrate support 210 for supporting the substrate conveyed through the entrance into the process chamber 100, moving the substrate to a position at which a power voltage is applied by the power voltage application part 300 to perform a crystallization process of a-Si, and providing a space in which the substrate is seated, a holder conveyor 230 for moving the substrate support 210, and a holder driver 220 for controlling the holder conveyor 230.

Here, while not shown in FIG. 1, the holder conveyor 230 may include a first holder conveyor (not shown) for moving the substrate support 210 horizontally, and a second holder conveyor (not shown) for moving the substrate support 210 vertically.

The substrate support 210 may include at least one vacuum hole 211 for discharging air between the substrate and the substrate support 210 to adhere the substrate to the substrate support 210. The vacuum hole 211 may be connected to a vacuum pump 600 to discharge the air between the substrate and the substrate support 210 therethrough so that the substrate is securely adhered to the substrate support 210.

In addition, the substrate support 210 may include a plurality of sensors 212 for detecting the size of the substrate. In this case, the controller 400 may control a distance between the first and second electrodes 310 and 320 depending on the size of the substrate detected by the plurality of sensors 212 so that the distance between the first and second electrodes 310 and 320 can be automatically adjusted depending on the size of the substrate without input from the exterior.

Here, the a-Si crystallization apparatus 1 in accordance with an exemplary embodiment detects a position of the substrate seated on the substrate support 210 using the plurality of sensors 212, and adjusts positions of the first and second electrodes 310 and 320 depending on the position of the substrate detected by the plurality of sensors 212 using the controller 400. Therefore, even when the substrate cannot be accurately seated on the substrate support 210, i.e., even when the substrate is biased toward an X- or Y-axis direction, it is possible to apply a power voltage to an accurate position on the substrate through the first and second electrodes 310 and 320.

The power voltage application part 300 functions to apply a certain power voltage to the conductive thin layer on the substrate to perform crystallization of the a-Si formed on the substrate, and includes the first and second electrodes 310 and 320 having different polarities, and a moving guide 330 for providing moving paths of the first and second electrodes 310 and 320 controlled by the controller 400.

Here, the first and second electrodes 310 and 320 have a certain length in a first direction X, and the moving guide 330 has a second length in a second direction Y perpendicular to the first direction X. As the first and second electrodes 310 and 320 move along the moving guide 330, it is possible for the first and second electrodes 310 and 320 to apply a certain power voltage to an accurate position on the substrate regardless of the size of the substrate seated on the substrate support 210.

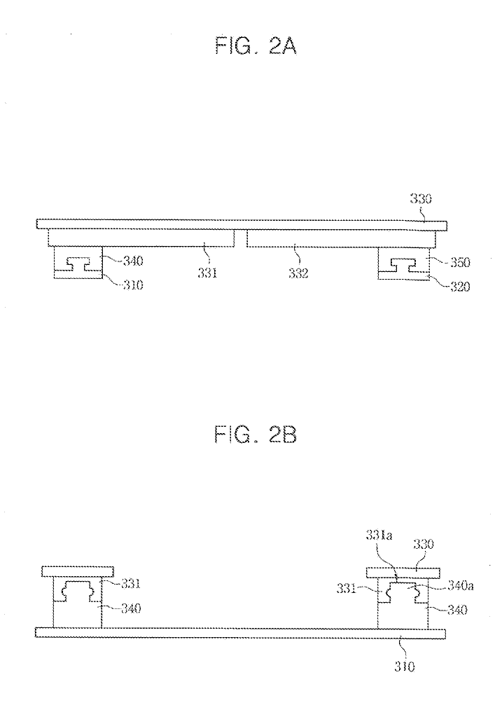

FIGS. 2A and 2B are cross-sectional views of the power voltage application part 300 of the a-Si crystallization apparatus in accordance with an exemplary embodiment. FIG. 2A is a cross-sectional view taken along line I-I′ of FIG. 1, and FIG. 2B is a cross-sectional view taken along line II-II′ of FIG. 1.

Referring to FIGS. 2A and 2B, the power voltage application part 300 including the first electrode 310, the second electrode 320 having a polarity different from the first electrode 310, and the moving guide 330 for providing moving paths to the first and second electrodes 310 and 320 may further include a first electrode conveyor 340 coupled between the first electrode 310 and the moving guide 330 and moving the first electrode 310 under control of the controller 400, and a second electrode conveyor 350 coupled between the second electrode 320 and the moving guide 330 and moving the second electrode 320 under control of the controller 400, in order to readily move and align the first and second electrodes 310 and 320.

Here, the moving guide 330 may include a first moving guide 331 for providing a moving path of the first electrode conveyor 340, and a second moving guide 332 for providing a moving path of the second electrode conveyor 350. In order to prevent collision between the first and second electrodes 310 and 320, the first and second moving guides 331 and 332 may be spaced a predetermined distance from each other.

In addition, the first and second moving guides 331 and 332 may have a certain length in the same direction to move the first and second electrodes 310 and 320 in the same direction so that positions of the first and second electrodes 310 and 320 can be more readily adjusted.

In the a-Si crystallization apparatus 1 in accordance with an exemplary embodiment, in order to securely couple the first moving guide 331 to the first electrode conveyor 340 and securely couple the second moving guide 332 to the second electrode conveyor 340, guide grooves 331a having a certain length in a Y-axis direction may be formed in the first and second moving guides 331 and 332, and guide rails 340a corresponding to the guide grooves 331a may be formed at the first and second conveyors 340 and 350.

Further, in the a-Si crystallization apparatus 1 in accordance with an exemplary embodiment, a rotary member (not shown) is disposed between the moving guide 330 and the process chamber 100 to rotate the moving guide 330 horizontally, and the controller 400 adjusts a distance between the first and second electrodes 310 and 320 and horizontal positions of the first and second electrodes 310 and 320. In addition, the plurality of sensors 212 of the substrate support 210 detect a position of the substrate seated on the substrate support 210, and the controller 400 adjusts positions of the first and second electrodes 310 and 320 and the rotary member depending on the position of the substrate detected by the plurality of sensors 212. As a result, the power voltage can be applied to an accurate position on the substrate through the first and second electrodes 310 and 320 without a separate alignment member or a separate alignment process of the substrate.

Eventually, the a-Si crystallization apparatus in accordance with an exemplary embodiment adjusts a distance between the first and second electrodes having different polarities to apply a certain power voltage to an accurate position on the substrate regardless of the size of the substrate introduced into the process chamber.

In addition, the a-Si crystallization apparatus in accordance with an exemplary embodiment includes the plurality of sensors disposed at the substrate support, on which the substrate is seated, and detecting the size of the substrate, so that the controller can adjust a distance between the first and second electrodes depending on the size of the substrate introduced into the process chamber without any input from the exterior.

As can be seen from the foregoing, an a-Si crystallization apparatus in accordance with the present invention includes first and second movable electrodes for applying a certain power voltage to a substrate and enabling adjustment of a distance between the first and second electrodes so that a crystallization process of a-Si formed of various sizes of substrates can be performed without modification of equipment.

Although a few embodiments have been shown and described, it would be appreciated by those skilled in the art that changes may be made in this embodiment without departing from the principles and spirit of the invention, the scope of which is defined in the claims and their equivalents.

What is claimed is:

1. An amorphous silicon crystallization apparatus comprising:
a process chamber;
a substrate holder disposed in one part of the process chamber;
a power voltage application part disposed in a part of the process chamber and including a first electrode and a second electrode having a polarity different from the first electrode; and
a controller for adjusting a distance between the first and second electrodes.

2. The amorphous silicon crystallization apparatus according to claim 1, wherein the substrate holder comprises: a substrate support for providing a space in which a substrate is seated, a holder conveyor for moving the substrate support, and a holder driver for controlling the holder conveyor.

3. The amorphous silicon crystallization apparatus according to claim 2, wherein the substrate support comprises at least one vacuum hole connected to a vacuum pump.

4. The amorphous silicon crystallization apparatus according to claim 2, wherein the substrate support comprises a plurality of sensors for detecting a size of the substrate.

5. The amorphous silicon crystallization apparatus according to claim 4, wherein the controller adjusts a distance between the first and second electrodes depending on the size of the substrate detected by the plurality of sensors.

6. The amorphous silicon crystallization apparatus according to claim 4, wherein the plurality of sensors detect a position of the substrate, and the controller adjusts positions of the first and second electrodes depending on the position of the substrate detected by the plurality of sensors.

7. The amorphous silicon crystallization apparatus according to claim 2, wherein the holder conveyor comprises: a first holder conveyor for moving the substrate support horizontally, and a second holder conveyor for moving the substrate support vertically.

8. The amorphous silicon crystallization apparatus according to claim 1, wherein the power voltage application part comprises: a first electrode conveyor for moving the first electrode, a second electrode conveyor for moving the second electrode, and a moving guide for providing moving paths of the first and second electrode conveyors.

9. The amorphous silicon crystallization apparatus according to claim 8, wherein the moving guide comprises a first moving guide for providing a moving path for the first electrode conveyor, and a second moving guide for providing a moving path for the second electrode conveyor,
wherein the first and second moving guides are spaced apart from each other.

10. The amorphous silicon crystallization apparatus according to claim 9, wherein the first and second moving guides are disposed in the same direction.

11. The amorphous silicon crystallization apparatus according to claim 9, wherein the first and second moving guides have guide grooves disposed in a longitudinal direction of the moving guide, and
the first and second electrode conveyors have guide rails corresponding to the guide grooves.

12. The amorphous silicon crystallization apparatus according to claim 8, wherein the moving guide is disposed in a direction perpendicular to a longitudinal direction of the first and second electrodes.
